(19) United States
(12) Patent Application Publication
(10) Pub. No.: US 2026/0332994 A1
(43) Pub. Date: Oct. 22, 2026

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Jinhua WU, Beijing (CN); Yang SHEN, Beijing (CN); Jianning LIU, Beijing (CN); Yuxin MAO, Beijing (CN)

(73) Assignee: Beijing Xiaomi Mobile Software Co., Ltd., Beijing (CN)

(21) Appl. No.: 19/102,342

(22) PCT Filed: Aug. 9, 2022
(86) PCT No.: PCT/CN2022/111295

§ 371 Date: Feb. 7, 2025

(51) Int. Cl. H04W 4/24; H04L 12/14; H04L 47/32; H04W 24/08

(52) U.S. Cl. CPC H04W 4/24; H04L 12/1407; H04L 47/32; H04W 24/08

(57) ABSTRACT

Embodiments of the present disclosure provide an information processing method and apparatus, a communication device, and a storage medium. The information processing method executed by a first network node may comprise: receiving packet dropping amount information of a protocol data unit (PUD) set sent by a second network node.

### CROSS-REFERENCE TO RELATED APPLICATIONS

This application is a national stage of International Application No. PCT/CN2022/111295, filed on Aug. 9, 2022, which is hereby incorporated by reference in its entirety.

### TECHNICAL FIELD

The present disclosure relates to, but is not limited to, the field of wireless communication technologies, and in particular, to an information processing method and apparatus, a communication device, and a storage medium.

### BACKGROUND

Mobile media services, extended reality (XR) services such as cloud augmented reality (AR) and virtual reality (VR), cloud game services, video-based remote control of machine or drone, etc., are expected to contribute increasingly much interest to 5G network.

In addition to audio and video flows, the XR service also involves multimodal data flows, such as data flows of biotactile sensing.

The multimodal data refers to data input from a same device or different devices (which may be a sensor) by a same service or application, and the data may be output to one or more target device terminals.

Data flows of the multimodal data are often in a certain, or even strong, correlation, such as synchronization of audio and video flows, and synchronization of tactility and visuality.

A data flow of such media service, data flows, and network transmission requirement of these service data flows all have common features, and effective identification and utilization of these features will be more helpful to transmission and control of the network and service, and also more helpful to service guarantee and user experience.

### SUMMARY

Embodiments of the present disclosure provide an information processing method and apparatus, a communication device, and a storage medium.

A first aspect of the embodiments of the present disclosure provides an information processing method, performed by a first network node, including: receiving packet dropping usage information of a protocol data unit (PDU) set sent by a second network node.

A second aspect of the embodiments of the present disclosure provides an information processing method, performed by a second network node, including: sending packet dropping usage information of a protocol data unit (PDU) set to a first network node.

A third aspect of the embodiments of the present disclosure provides an information processing method, performed by a third network node, including: sending packet dropping usage information of a protocol data unit (PDU) set to a second network node.

A fourth aspect of the embodiments of the present disclosure provides an information processing method, performed by an access network node, including: sending a dropped data packet of a protocol data unit (PDU) set to a second network node, where the dropped data packet includes a dropping mark.

A fifth aspect of the embodiments of the present disclosure provides an information processing apparatus, including: a receiving module, configured to receive packet dropping usage information of a protocol data unit (PDU) set sent by a second network node.

A sixth aspect of the embodiments of the present disclosure provides an information processing apparatus, including: a sending module, configured to send packet dropping usage information of a protocol data unit (PDU) set to a second network node.

A seventh aspect of the embodiments of the present disclosure provides an information processing apparatus, including: a sending module, configured to send a dropped data packet of a protocol data unit (PDU) set to a second network node, where the dropped data packet includes a dropping mark.

An eighth aspect of the embodiments of the present disclosure provides a communication system, including a first network node, a second network node, and a third network node; where the third network node is configured to send packet dropping usage information of a protocol data unit (PDU) set to the second network node; the second network node is configured to receive the packet dropping usage information sent by the third network node and send the packet dropping usage information to the first network node; and the first network node is configured to receive the packet dropping usage information sent by the second network node, and correct a charging usage, or determine a traffic restriction, or both, according to the packet dropping usage information.

A ninth aspect of the embodiments of the present disclosure provides a communication device, including a processor, a transceiver, a memory, and an executable program stored in the memory and executable by the processor, where when the processor executes the executable program, the information processing method according to any one of first to eighth aspects is performed.

A tenth aspect of the embodiments of the present disclosure provides a computer storage medium, where the computer storage medium stores an executable program, and after the executable program is executed by a processor, the information processing method provided in any one of the first to ninth aspects can be implemented.

According to the technical solution provided in the embodiments of the present disclosure, the first network node obtains the packet dropping usage information of the PDU set from the second network node, to implement monitoring of the packet dropping usage of the PDU set, so as to correct charging and/or update policy information based on the monitored packet dropping usage information when needed, on one hand, precise charging is achieved and on the other hand, policy information can be updated in time to improve communication service quality.

It should be understood that the above general description and the following detailed description are only examples and illustrative, and do not limit the embodiments of the present disclosure.

### BRIEF DESCRIPTION OF DRAWINGS

The accompanying drawings, which are incorporated in and constitute a part of this specification, illustrate embodiments consistent with the present disclosure, and together with the description serve to explain the principles of the embodiments of the present disclosure.

FIG. 1 is a schematic structural diagram of a wireless communication system according to an example embodiment.

FIG. 2 is a schematic flowchart of an information processing method according to an example embodiment.

FIG. 3A is a schematic flowchart of an information processing method according to an example embodiment.

FIG. 3B is a schematic flowchart of an information processing method according to an example embodiment.

FIG. 3C is a schematic flowchart of an information processing method according to an example embodiment.

FIG. 3D is a schematic flowchart of an information processing method according to an example embodiment.

FIG. 4A is a schematic flowchart of an information processing method according to an example embodiment.

FIG. 4B is a schematic flowchart of an information processing method according to an example embodiment.

FIG. 4C is a schematic flowchart of an information processing method according to an example embodiment.

FIG. 4D is a schematic flowchart of an information processing method according to an example embodiment.

FIG. 5A is a schematic flowchart of an information processing method according to an example embodiment.

FIG. 5B is a schematic flowchart of an information processing method according to an example embodiment.

FIG. 5C is a schematic flowchart of an information processing method according to an example embodiment.

FIG. 6A is a schematic flowchart of an information processing method according to an example embodiment.

FIG. 6B is a schematic flowchart of an information processing method according to an example embodiment.

FIG. 7 is a schematic flowchart of an information processing method according to an example embodiment.

FIG. 8 is a schematic flowchart of an information processing method according to an example embodiment.

FIG. 9 is a schematic flowchart of an information processing method according to an example embodiment.

FIG. 10 is a schematic structural diagram of an information processing apparatus according to an example embodiment.

FIG. 11 is a schematic structural diagram of an information processing apparatus according to an example embodiment.

FIG. 12 is a schematic structural diagram of an information processing apparatus according to an example embodiment.

FIG. 13 is a schematic structural diagram of an information processing apparatus according to an example embodiment.

FIG. 14 is a schematic structural diagram of a network device according to an example embodiment.

### DETAILED DESCRIPTION

Example embodiments will be described in detail herein, examples of which are illustrated in the accompanying drawings. When following description refers to the drawings, unless otherwise indicated, same numerals in different drawings indicate same or similar elements. The embodiments described in the following example embodiments do not represent all embodiments consistent with the embodiments of the present disclosure. Instead, they are merely examples of apparatuses and methods consistent with some aspects of the embodiments of the present disclosure.

The terminology used in the embodiments of the present disclosure is for the purpose of describing particular embodiments only and is not intended to limit the embodiments of the present disclosure. The singular forms “a/an”, “the”, and “said” used in the present disclosure are also intended to include plural forms unless the context clearly indicates other meanings. It should also be understood that the term “and/or” as used herein refers to and includes any or all possible combinations of one or more associated listed item.

It should be understood that although the terms “first”, “second”, “third”, etc., may be used to describe various information in the embodiments of the present disclosure, this information should not be limited to these terms. These terms are only used to distinguish a same type of information from each other. For example, without departing from the scope of the embodiments of the present disclosure, “first information” may also be referred to as “second information”, and similarly, “second information” may also be referred to as “first information”. Depending on context, the word “if” as used herein may be interpreted as “when” or “upon” or “in response to determining”.

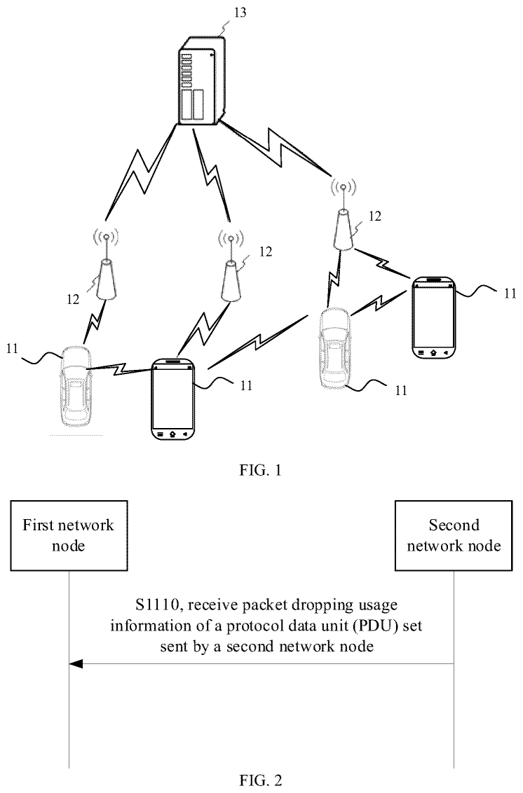

Referring to FIG. 1, FIG. 1 is a schematic structural diagram of a wireless communication system according to an embodiment of the present disclosure. As shown in FIG. 1, the wireless communication system is a communication system based on a cellular mobile communication technology, and the wireless communication system may include: several user equipments (UEs) 11 and several access devices 12.

The UE 11 may include a device that provides voice and/or data connectivity to a user. The UE 11 may communicate with one or more core networks by using a radio access network (RAN), and the UE 11 may include Internet of Things UE, for example, a sensor device, a mobile phone (or referred to as a cellular phone), and a computer having Internet of Things UE, for example, may be a fixed, portable, pocket-sized, handheld, computer built-in, or vehicle-mounted apparatus. For example, a station (STA), a subscriber unit, a subscriber station, a mobile station, a mobile, a remote station, an access point, a remote terminal, an access terminal, a user terminal, a user agent, a user device, or a user equipment (UE). Alternatively, the UE 11 may be a device of an unmanned aerial vehicle. Alternatively, the UE 11 may be an in-vehicle device, for example, may be an automotive computer having a wireless communication function, or may be a wireless communication device externally connected to an automotive computer. Alternatively, the UE 11 may be a roadside device, for example, a street lamp, a signal light, or other roadside devices having a wireless communication function.

The access device 12 may be a network side device in a wireless communication system. The wireless communication system may be a 4th generation (4G) mobile communication system, also referred to as a long-term evolution (LTE) system; or the wireless communication system may be a 5G system, also referred to as a new radio (NR) system or a 5G NR system. Alternatively, the wireless communication system may be a next-generation system of a 5G system. The access network in the 5G system may be referred to as a NG-RAN (New Generation-Radio Access Network). Or an MTC (Manual Toll Collection) system.

The access device 12 may be an evolved access device (eNB) used in a 4G system. Alternatively, the access device 12 may be an access device (gNB) that uses a centralized-distributed architecture in a 5G system. When using a centralized-distributed architecture, the access device 12 usually includes a central unit (CU) and at least two distributed units (DUs). A protocol stack of a packet data convergence protocol (PDCP) layer, a radio link control (RLC) layer, and a media access control (MAC) layer is disposed in the central unit; and a protocol stack of a physical (PHY) layer is disposed in the distributed unit, and a specific implementation of the access device 12 is not limited in the embodiments of the present disclosure.

A wireless connection may be established between the access device 12 and the UE 11 through a wireless air interface. In different implementations, the wireless air interface is based on a fourth-generation mobile communication network technology (4G) standard; or the wireless air interface is based on a fifth-generation mobile communications network technology (5G) standard, for example, the wireless air interface is a new air interface; or the wireless air interface may be based on a 5G next-generation mobile communication network technology standard.

To achieve accurate statistics on charging usage of a data level such as a flow or a session in a PDU set, or to timely update and control flows and sessions of the PDU set, or all PDU flows transmitted by a session slice of a UE, the following provides several optional manners.

A first aspect of the embodiments of the present disclosure provides an information processing method, performed by a first network node, including: receiving packet dropping usage information of a protocol data unit (PDU) set sent by a second network node.

It shall be understood that the method further includes: determining a traffic restriction based on the packet dropping usage information; and/or correcting charging usage based on the packet dropping usage information.

It may be understood that a data level related to the PDU set includes at least one of: a service data flow (SDF); a PDU session; or all PDU sessions transmitted by a network slice of a user equipment (UE).

It shall be understood that determining the traffic restriction based on the packet dropping usage information includes: updating a policy control and charging (PCC) rule of policy information according to the packet dropping usage information.

It shall be understood that updating the PCC rule of the policy information according to the packet dropping usage information includes: updating a quality of service (QOS) parameter of the PCC rule according to the packet dropping usage information; and/or, updating a charging key of the PCC rule according to the packet dropping usage information.

It shall be understood that the QoS parameter includes at least one of: a PDU set delay budget (PSDB); a PDU set error rate (PSER); first indication information, indicating whether all data packets in the PDU set are needed by an application layer; second indication information, indicating whether to allow packet dropping in a case that the PDU set meets a preset condition; or a priority of the PDU set.

It shall be understood that determining the traffic restriction based on the packet dropping usage information further includes: allowing intended packet dropping according to the packet dropping usage information; or prohibiting intended packet dropping according to the packet dropping usage information.

It shall be understood that determining the traffic restriction based on the packet dropping usage information includes: determining the traffic restriction based on the packet dropping usage information in a case that a packet dropping usage indicated by the packet dropping usage information is greater than or equal to a packet dropping threshold.

It shall be understood that the packet dropping threshold includes at least one of: a packet dropping usage percentage; or a packet dropping usage.

The first network node includes a policy control function (PCF).

A second aspect of the embodiments of the present disclosure provides an information processing method, performed by a second network node, including: sending packet dropping usage information of a protocol data unit (PDU) set to a first network node.

It shall be understood that the method further includes: receiving, according to a monitoring key, the packet dropping usage information of the PDU set from a third network node.

It shall be understood that receiving, according to the monitoring key, the packet dropping usage information of the PDU set from the third network node includes: receiving, according to a monitoring key, the packet dropping usage information of the PDU set from a third network node.

It shall be understood that the method further includes: receiving, according to a monitoring key, a dropped data packet in the PDU set sent by a third network node, where the dropped data packet includes a dropping mark; and determining the packet dropping usage information of the PDU set based on the dropped data packet.

It shall be understood that the third network node includes a user plane function (UPF).

It shall be understood that the method further includes: acquiring, according to a monitoring key, the packet dropping usage information of the PDU set from an access network node.

It shall be understood that, acquiring, according to the monitoring key, the packet dropping usage information of the PDU set from the access network node includes: receiving, according to the monitoring key, the packet dropping usage information of the PDU set from the access network node.

It shall be understood that the method further includes: receiving, according to a monitoring key, a dropped data packet in the PDU set sent by an access network node, where the dropped data packet includes a dropping mark; and determining the packet dropping usage information of the PDU set based on the dropped data packet.

It shall be understood that the access network node is an access network node.

It shall be understood that the monitoring key is preconfigured on the second network node; or, the monitoring key is received by the second network node from the first network node.

It shall be understood that the packet dropping usage information is used by the first network node to correct charging usage, or update policy information, or both.

It shall be understood that the second network node includes a session management function (SMF).

A third aspect of the embodiments of the present disclosure provides an information processing method, performed by a second network node, including: receiving packet dropping usage information of a protocol data unit (PDU) set sent by a third network node; correcting a charging usage according to the packet dropping usage information; and sending the corrected charging usage to a charging function.

A fourth aspect of the embodiments of the present disclosure provides an information processing method, performed by a second network node, including: receiving packet dropping usage information of a protocol data unit (PDU) set sent by an access network node; correcting a charging usage according to the packet dropping usage information; and sending the corrected charging usage to a charging function.

A fifth aspect of the embodiments of the present disclosure provides an information processing method, performed by a second network node, including: receiving a dropped data packet of a protocol data unit (PDU) set sent by a third network node, where the dropped data packet includes a dropping mark; determining the packet dropping usage information of the PDU set based on the dropped data packet; correcting a charging usage according to the packet dropping usage information; and sending the corrected charging usage to a charging function.

It shall be understood that the method further includes: determining, based on PDU set information, that data packets received by the second network node belong to a same PDU set.

It may be understood that the PDU set information includes: intra-PDU set information and/or inter-PDU set information.

It shall be understood that the intra-PDU set information includes at least one of: a PDU set sequence number; start indication information of a PDU set; end indication information of the PDU set; or a PDU sequence number within the PDU set.

It shall be understood that the inter-PDU set information includes at least one of: importance indication information, indicating importance of a corresponding PDU set; or independency indication information, indicating whether the PDU set depends on another PDU set.

It shall be understood that determining, based on the PDU set information, that the data packets received by the second network node belong to the same PDU set includes: determining, based on the PDU set information and at least one of a header or a flow feature of a data packet, whether the corresponding data packet belongs to the PDU set.

A sixth aspect of the embodiments of the present disclosure provides an information processing method, performed by a second network node, including: receiving a dropped data packet of a protocol data unit (PDU) set sent by an access network node, where the dropped data packet includes a dropping mark; determining the packet dropping usage information of the PDU set based on the dropped data packet; correcting a charging usage according to the packet dropping usage information; and sending the corrected charging usage to a charging function.

It shall be understood that the method further includes: determining, based on PDU set information, that data packets received by the second network node belong to a same PDU set.

It may be understood that the PDU set information includes: intra-PDU set information and/or inter-PDU set information.

It shall be understood that the intra-PDU set information includes at least one of: a PDU set sequence number; start indication information of a PDU set; end indication information of the PDU set; or a PDU sequence number within the PDU set.

It shall be understood that the inter-PDU set information includes at least one of: importance indication information, indicating importance of a corresponding PDU set; or independency indication information, indicating whether the PDU set depends on another PDU set.

It shall be understood that determining, based on the PDU set information, that the data packets received by the second network node belong to the same PDU set includes: determining, based on the PDU set information and at least one of a header or a flow feature of a data packet, whether the corresponding data packet belongs to the PDU set.

A seventh aspect of the embodiments of the present disclosure provides an information processing method, performed by a third network node, including: sending packet dropping usage information of a protocol data unit (PDU) set to a second network node.

It shall be understood that the method further includes: receiving the packet dropping usage information of the PDU set sent by an access network node.

It shall be understood that the method further includes: receiving a dropped data packet in the PDU set sent by the access network node; determining the packet dropping usage information of the PDU set based on the dropped data packet, where the dropped data packet includes a dropping mark.

An eighth aspect of the embodiments of the present disclosure provides an information processing method, performed by an access network node, including: sending a dropped data packet of a protocol data unit (PDU) set to a second network node, where the dropped data packet includes a dropping mark.

It shall be understood that the method further includes: receiving PDU set information from a third network node; and determining, based on the PDU set information, that data packets received by an access network node belong to a same PDU set.

It may be understood that the PDU set information includes: intra-PDU set information and/or inter-PDU set information.

It shall be understood that determining, based on the PDU set information, that the data packets received by the access network node belong to the same PDU set includes: determining, based on the PDU set information and at least one of a header or a flow feature of a data packet, whether the data packet received by the access network node belongs to the PDU set.

A ninth aspect of the embodiments of the present disclosure provides an information processing method, performed by an access network node, including: sending a dropped data packet of a protocol data unit (PDU) set to a third network node, where the dropped data packet includes a dropping mark.

It shall be understood that the method further includes: receiving PDU set information from a third network node; and determining, based on the PDU set information, that data packets received by a access network node belong to a same PDU set.

It may be understood that the PDU set information includes: intra-PDU set information and/or inter-PDU set information.

It shall be understood that determining, based on the PDU set information, that the data packets received by the access network node belong to the same PDU set includes: determining, based on the PDU set information and at least one of a header or a flow feature of a data packet, whether the data packet received by the access network node belongs to the PDU set.

A tenth aspect of the embodiments of the present disclosure provides an information processing method, performed by an access network node, including: sending packet dropping usage information of a protocol data unit (PDU) set to a second network node.

It shall be understood that the method further includes: receiving PDU set information from a third network node; and determining, based on the PDU set information, that data packets received by a access network node belong to a same PDU set.

It may be understood that the PDU set information includes: intra-PDU set information and/or inter-PDU set information.

It shall be understood that determining, based on the PDU set information, that the data packets received by the access network node belong to the same PDU set includes: determining, based on the PDU set information and at least one of a header or a flow feature of a data packet, whether the data packet received by the access network node belongs to the PDU set.

As shown in FIG. 2, an embodiment of the present disclosure provides an information processing method, performed by a first network node, including:
Step 1110: receiving packet dropping usage information of a protocol data unit (PDU) set sent by a second network node.

The first network node may include a core network node, and for example, the first network node may include a policy control function (PCF). The second network node may also include a core network node. The second network node may include a session management function (SMF).

The first network node and the second network node are different network nodes in a network, that is, different network devices.

The PDU set may include a set of PDUs. The set of PDUs may include one or more PDUs. One PDU may be one data packet.

For example, data packets in a PDU set may be in a certain association. For example, the data packets in the PDU set may be data packets of a same video frame, or data packets of a plurality of video frames that have an interdependency relationship. For another example, the data packet in the PDU set may be input data of one or more devices of multimodal data, output data of one or more devices, or the like. For another example, the data packets in the PDU set may be different types of associated data packets of the XR service.

In the embodiment of the present disclosure, the PDU set may be a downlink PDU set and/or an uplink PDU set.

The dropping of the data packet in the PDU set may be a packet dropping in any network node, for example, the dropping of the data packet may occur in an access network, so that a network node that drops the data packet is an access network node. Certainly, the packet dropping may also occur in a core network, and the network node that drops the data packet may be the above core network node. The core network node includes but is not limited to a user plane function (UPF).

Certainly, this is merely an example of a data packet in the PDU set, and specific implementation is not limited to any one of the above examples.

The packet dropping usage information may indicate an amount of data of dropped data packets in the PDU set.

By obtaining the packet dropping usage information, the second network node can accurately collect statistics on usage transmitted by the network to the terminal, and/or more accurately control quality of service (QoS) of a flow and/or a session related to the PDU set of the terminal based on the packet dropping usage information.

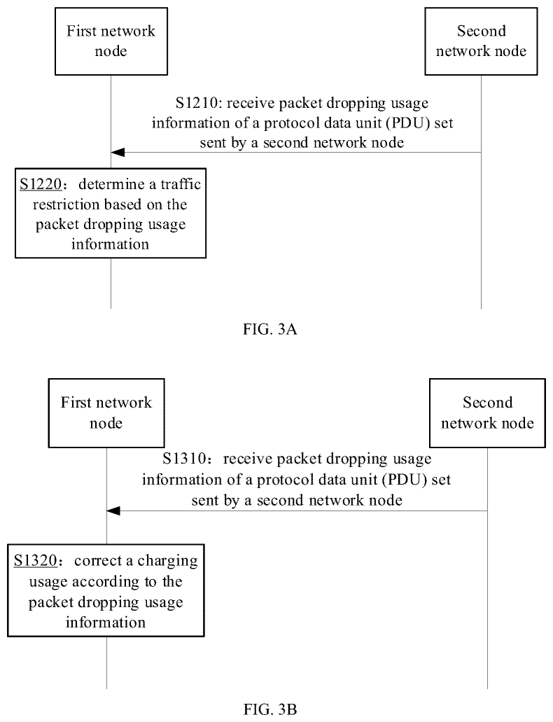

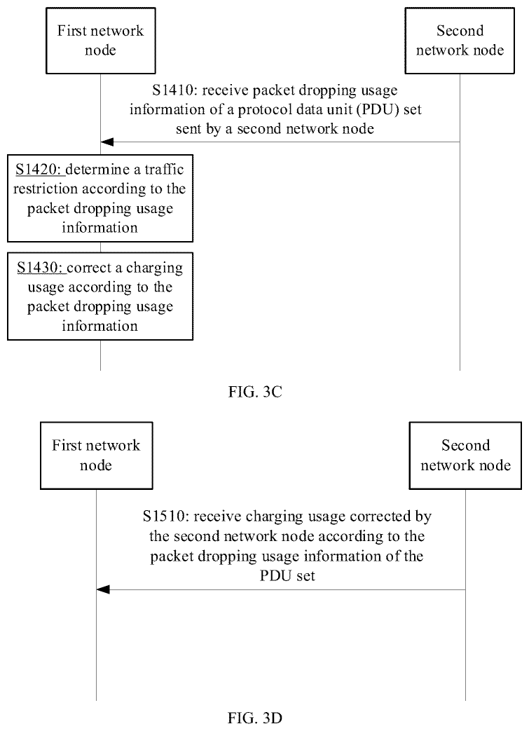

As shown in FIG. 3A, an embodiment of the present disclosure provides an information processing method, performed by a first network node, including:
S1210: receiving packet dropping usage information of a protocol data unit (PDU) set sent by a second network node.
S1220: determining a traffic restriction based on the packet dropping usage information.

In the embodiment of the present disclosure, the first network node may determine the traffic restriction according to the packet dropping usage information, and the traffic restriction is for a flow or a session of the PDU set.

For example, S1220 may include: strengthening traffic restriction and/or relaxing traffic restriction.

For example, to strengthen the traffic restriction may refer to further refine packet dropping of the PDU set. Relaxing the traffic restriction may refer to: the network node based on the transmitted PDU set may relax the packet dropping restriction, so that the network node selects to drop packets more autonomously based on a network congestion status and/or a data packet transmission requirement.

The above is merely an example of strengthening traffic restriction and/or relaxing traffic restriction, and specific implementation is not limited to the above example.

As shown in FIG. 3B, an embodiment of the present disclosure provides an information processing method, performed by a first network node, including:
S1310: receiving packet dropping usage information of a protocol data unit (PDU) set sent by a second network node.
S1320: correcting a charging usage according to the packet dropping usage information.

The charging usage herein is network traffic involved in fee accounting.

In the embodiment of the present disclosure, after receiving the packet dropping usage information, the first network node may correct charging usage of a flow or a session in the PDU set, so as to make charging more accurate.

As shown in FIG. 3C, an embodiment of the present disclosure provides an information processing method, performed by a first network node, including:
S1410: receiving packet dropping usage information of a protocol data unit (PDU) set sent by a second network node;
S1420: determining a traffic restriction according to the packet dropping usage information; and
S1430: correcting a charging usage according to the packet dropping usage information.

In some embodiments, after receiving the packet dropping usage information of the PDU set, the first network node determines traffic restriction and at the same time corrects charging usage, so that on one hand, more precise control can be implemented on transmission of the PDU set, and on the other hand, accurate charging is achieved.

It should be noted that there is no defined order for S1420 and S1430, and S1420 and S1430 may be performed together, or be performed one after another.

In some other embodiments, after the first network node receives the packet dropping usage information of the PDU set, if it is considered that the amount of data generated by packet dropping indicated by the packet dropping usage information is within an acceptable range, and the amount of data generated by the current packet dropping is within an acceptable range, there is no need to re-determine the traffic restriction or correct the charging usage, and the first network node only stores the packet dropping usage information or even deletes the packet dropping usage information.

In some embodiments, as shown in FIG. 3D, an embodiment of the present disclosure provides an information processing method, performed by a first network node, including:
S1510: receiving charging usage corrected by the second network node according to the packet dropping usage information of the PDU set.

In the embodiment, the second network node monitors the packet dropping usage of the PDU set, and obtains the packet dropping usage information. After obtaining the packet dropping usage information, the second network node performs charging usage correction on the flow or the session in the PDU set, and in this case, the first network node receives the corrected charging usage. The first network node may charge based on the corrected charging usage. After receiving the corrected charging usage, the first network node may provide a charging system, and the charging system performs accurate charging. For example, the first network node may send to a charging function (CHF) of a charging system.

In some embodiments, a data level related to the PDU set includes at least one of: a service data flow (SDF); a PDU session; or all PDU sessions transmitted by a network slice of a user equipment (UE).

Different services generate different service data flows.

One PDU session may include one or more service data flows.

One UE may subscribe to use one or more network slices. Since data flows or PDU sessions using a same network slice may have a same charging status and a same traffic restriction, unified packet dropping usage statistics may also be performed for a single network slice of a single UE.

As described above, in the embodiments of the present disclosure, the statistics on the packet dropping usage information of the PDU set may involve different data levels, so as to meet the requirement of conducting statistics without considering the data level. Certainly, the above is merely an example of data levels for statistics of the packet dropping usage information, and specific implementation is not limited to the above example.

In some embodiments, determining the traffic restriction based on the packet dropping usage information includes: updating a policy control and charging (PCC) rule of policy information according to the packet dropping usage information.

In the embodiments of the present disclosure, determining of the traffic restriction is implemented by updating the PCC rule.

For example, if the traffic restriction is updated, the updated traffic restriction is reflected by the updated PCC rule.

When the PCC rule is updated, all of or part of PCC rules in the entire policy information may be updated.

For example, updating the PCC rule of the policy information according to the packet dropping usage information includes: updating a quality of service (QOS) parameter of the PCC rule according to the packet dropping usage information; and/or, updating a charging key of the PCC rule according to the packet dropping usage information.

For example, the packet dropping usage information of the service data flow or session in the PDU set may be adjusted by updating the QoS parameter in the PCC rule. For another example, charging of the service data flow or session in the PDU set may be adjusted by updating a charging key in the PCC rule. Different charging keys may be mapped to different charging rules, so as to update the charging rules.

In some embodiments, the QoS parameter includes at least one of: a PDU set delay budget (PSDB); a PDU set error rate (PSER); first indication information, indicating whether all data packets in the PDU set are needed by an application layer; second indication information, indicating whether to allow packet dropping in a case that the PDU set meets a preset condition; or a priority of the PDU set.

If the PDU set delay budgets are different, when transmitting a data packet of the PDU set, the network node may select a specific bandwidth or transmission priority based on a corresponding delay budget to transmit the data packet.

Lower PDU set error rate requires better error control in a data packet transmission process, and a corresponding network resource also needs to be scheduled for transmission.

The first indication information indicates whether all data packets in the PDU set are needed by an application layer, which may be considered for the network node to selectively drop data packets when required, for example, non-needed data packets in the application layer may be selected to be dropped. If all data packets in one PDU set are needed by the application layer, the network node needs to avoid packet dropping as much as possible when transmitting data packets.

The second indication information may indicate that a data packet in the PDU set can be dropped, but a specific condition needs to be met.

For example, the PSDB of the data packet in the PDU set being greater than a delay threshold indicates that the data packet in the PDU set is not an urgent data packet, and the data packet is dropped at the moment of network congestion, a delay corresponding to the PSDB may be reached even through retransmission, thus the packet can be dropped, that is, the preset condition is determined to be met.

For another example, if an actual error rate of the data packet in the PDU set is greater than the PSER defined by the QoS parameter, it may not make sense that the network node continues to transmit the data packet in the PDU set, thus the preset condition is determined to be met, and the data packet is dropped.

As described above, the QoS parameter may be an example of QoS parameters of the PDU set, and specific implementation is not limited to the above example.

Further, the QoS parameter may be defined by the PCC rule.

In some embodiments, determining the traffic restriction based on the packet dropping usage information further includes: allowing intended packet dropping according to the packet dropping usage information; or, prohibiting intended packet dropping according to the packet dropping usage information.

When determining the traffic restriction, in addition to determining the policy information according to the packet dropping usage information, it may also be implemented by directly restricting a behavior of the network node, for example, it is directly restricted that for which network node the intended packet dropping is allowed or prohibited.

The network node herein includes but is not limited to an access network node and/or a core network node.

For example, if packet dropping is allowed, the network node may intentionally drop a corresponding data packet when network congestion occurs or an error rate of the data packet is found to be high; and if packet dropping is prohibited, and the network node may not be allowed to drop the corresponding data packet even if the network congestion occurs or an error rate of the data packet is found to be high. In a scenario in which packet dropping is prohibited, the network node that performs data packet transmission may drop packets in some special scenarios, for example, the terminal device indicates that packet dropping is allowed, packet dropping is requested, or a management device indicates that packet dropping is allowed.

In some embodiments, if usage of dropped data packets of the PDU set is large and continuing packet dropping would affects a function of the PDU set, intended packet dropping may be prohibited, and packet dropping is restricted for the network node, to ensure a transmission success rate of the PDU set in time.

In some other embodiments, if large amount of data packets in the PDU set are not required by an application layer of the terminal device, and packet dropping usage of the current PDU set is small, and congestion occurs in the network, then prohibiting of dropping packets is modified to allowing dropping packets, so that the network node may drop data packets in one or more PDU sets.

In some embodiments, updating the policy information based on the packet dropping usage information includes: determining that the packet dropping threshold is reached or exceeded based on the packet dropping usage information, and updating the policy information according to the packet dropping usage information.

That is, when the amount of data of the dropped packets is indicated by some packet dropping usage information to be greater than or equal to the packet dropping threshold, it indicates that the policy information needs to be updated, in this case, the first network node updates the policy information based on the packet dropping usage information, for example, the QoS parameter and/or the charging key of the PCC rule of the policy information is updated.

In an example, the packet dropping threshold includes at least one of: a packet dropping usage percentage; or, a packet dropping usage.

The packet dropping usage percentage may be: a ratio of the amount of data of the dropped data packets in the PDU set to an amount of data of all data packets in the PDU set.

If the actual packet dropping usage percentage in the PDU set is greater than or equal to the packet dropping usage percentage corresponding to the packet dropping threshold, the first network node updates the policy information.

The packet dropping usage herein may be the amount of data of the dropped data packets, and if the actual packet dropping usage in the PDU set is greater than or equal to the packet dropping usage corresponding to the packet dropping threshold, the first network node updates the policy information.

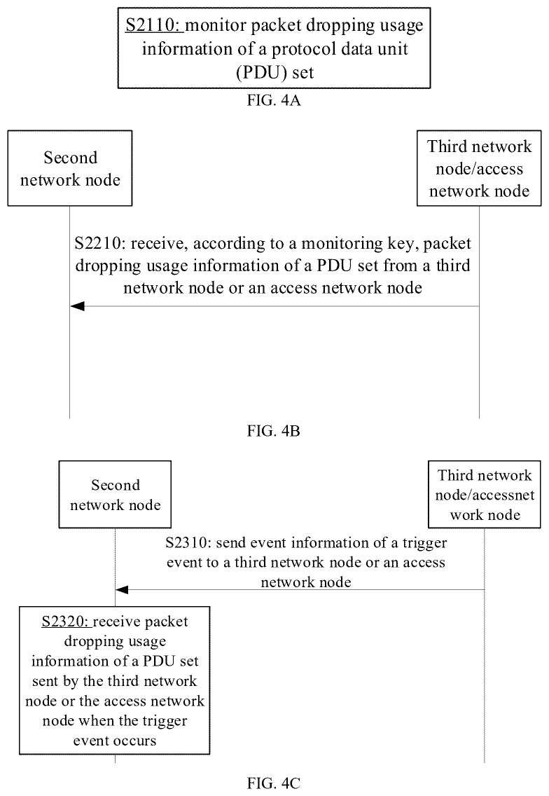

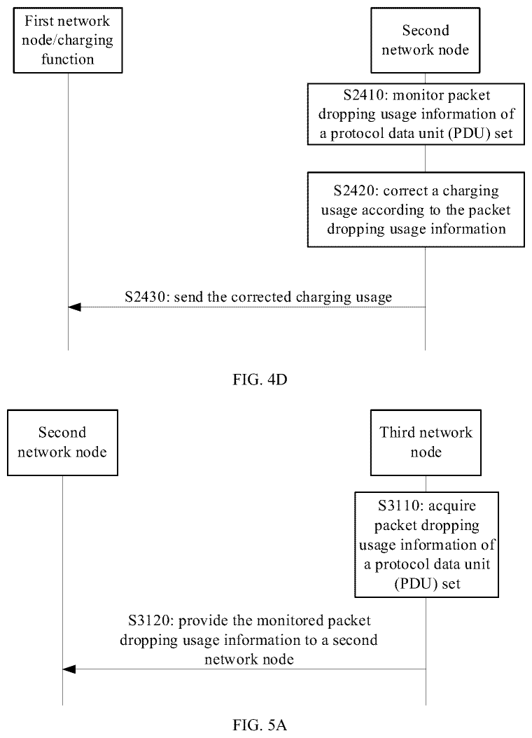

As shown in FIG. 4A, an embodiment of the present disclosure provides an information processing method, performed by a second network node, including:
S2110: monitoring packet dropping usage information of a protocol data unit (PDU) set.

The second network node includes but is not limited to an SMF.

The SMF monitors the packet dropping usage information of the PDU set. The packet dropping usage information at least indicates packet dropping usage of data packets in the PDU set.

The monitored packet dropping usage information may be used to correct charging and/or update policy of a service data flow or a PDU session in the PDU set.

In some possible embodiments, the method further includes: sending the packet dropping usage information to a first network node, where the packet dropping usage information is used for charging usage correction and/or policy updating by the first network node.

After detecting the packet dropping usage information, the second network node sends the packet dropping usage information to the first network node when a specific condition is met, for example, sends the packet dropping usage information to the first network node when a reporting period is reached, or sends the packet dropping usage information to the second network node when a reporting event is detected.

The first network node herein includes but is not limited to a PCF.

As shown in FIG. 4B, an embodiment of the present disclosure provides an information processing method, performed by a second network node, including:
S2210: receiving, according to a monitoring key, packet dropping usage information of a PDU set from a third network node.

The second network node monitors the packet dropping usage information of one or more PDU sets based on one monitoring key.

For example, the second network node obtains the packet dropping usage information of the PDU set from the third network node and/or the access network node that transmit the data packet of the monitoring key.

For example, the third network node may include a UPF. The access network node may be an access network node such as an eNB or a gNB.

In some embodiments, obtaining, according to the monitoring key, the packet dropping usage information of the PDU set from the third network node or the access network node includes: receiving, according to the monitoring key, a report sent by the third network node or the access network node; where the report includes packet dropping usage information of the PDU set.

In some embodiments, the report may be sent periodically, or the report is reported when the third network node or the access network node determines that a trigger event is satisfied.

The third network node and the access network node may report the packet dropping usage information to the second network node in a reporting manner. Certainly, the packet dropping usage information may also be reported to the second network node in another message signaling manner, and a specific implementation manner is not limited to the above report.

As shown in FIG. 4C, an embodiment of the present disclosure provides an information processing method, performed by a second network node, including:
S2310: sending event information of a trigger event to a third network node or an access network node.
S2320: receiving packet dropping usage information of a PDU set sent by the third network node or the access network node when the trigger event occurs.

The third network node and the access network node report the packet dropping usage information of the PDU set only when detecting that the trigger event occurs, thereby reducing unnecessary frequent reporting.

In some embodiments, the monitoring key is preconfigured on the second network node; or the monitoring key is received by the second network node from the first network node.

For example, when subscribing to some services, the terminal may preconfigure the monitoring key, and preconfigure the monitoring key on the second network node.

For example, when a session or a service data flow is established or updated, the first network node sends the monitoring key to the second network node.

After receiving the monitoring key, the second network node can monitor a service data flow, a PDU session, or all PDU sessions of a single network slice of a single UE single based on the monitoring key. In some embodiments, the method further includes: determining, based on at least one of policy information provided by a PCF, authorization information of the first network node, or local configuration information of the second network node, the packet dropping threshold related to the trigger event.

In some embodiments, there may be various types of trigger events, one of which is related to the packet dropping threshold. If the trigger event is related to the packet dropping threshold, the packet dropping threshold may be directly specified by the policy information, or may be determined by the second network node according to at least one of the policy information, the authorization information of the first network node, or the local configuration information of the second network node.

After the packet dropping threshold is carried in event information and sent to the third network node and/or the access network node, statistics collected by the third network node or the fourth network node based on the amount of data of the dropped data packets in the PDU set reaches the packet dropping threshold, and the second network node receives the packet dropping usage information sent by the third network node or the access network node.

As shown in FIG. 4D, an embodiment of the present disclosure provides an information processing method, performed by a second network node, including:
S2410: monitoring packet dropping usage information of a protocol data unit (PDU) set;
S2420: correcting a charging usage according to the packet dropping usage information; and
S2430: sending the corrected charging usage.

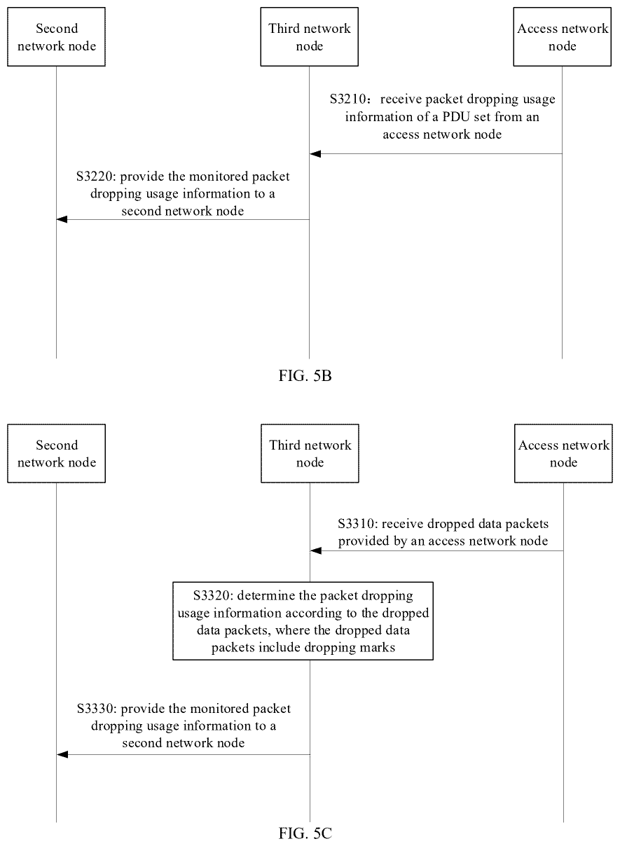

In the embodiment, the second network node monitors the packet dropping usage of the PDU set, and obtains the packet dropping usage information. After obtaining the packet dropping usage information, the second network node performs charging usage correction on the flow or the session in the PDU set, and in this case, the first network node or the CHF receives the corrected charging usage. As shown in FIG. 5A, an embodiment of the present disclosure provides an information processing method, performed by a third network node, including:
S3110: acquiring packet dropping usage information of a protocol data unit (PDU) set.
S3120: providing the monitored packet dropping usage information to a second network node.

The third network node herein includes but is not limited to a UPF.

In this embodiment of the present disclosure, the third network node obtains the packet dropping usage information of the PDU set, and an obtaining manner may include: the third network node directly receives the packet dropping usage information from the access network node, or the third network node collects statistics on an amount of data of the packet dropping to obtain the packet dropping usage information.

After obtaining the packet dropping usage information, the third network node submits the packet dropping usage information to the second network node, so that the second network node performs traffic restriction and/or charging correction on the data flow and/or the PDU session in the PDU set based on the packet dropping usage information.

As shown in FIG. 5B, an embodiment of the present disclosure provides an information processing method, performed by a third network node, including:
S3210: receiving packet dropping usage information of a PDU set from an access network node;
S3310: providing the monitored packet dropping usage information to a second network node.

In an embodiment of the present disclosure, if the access network node drops a data packet, the access network node will collect statistics on the amount of dropped data for each PDU set to obtain the packet dropping usage information, and send the packet dropping usage information to the third network node.

As shown in FIG. 5C, an embodiment of the present disclosure provides an information processing method, performed by a third network node, including:
S3310: receiving dropped data packets provided by an access network node;
S3320: determining the packet dropping usage information according to the dropped data packets, where the dropped data packets include dropping marks;
S3330: providing the monitored packet dropping usage information to a second network node.

In the embodiment of the present disclosure, the access network node does not collect statistics on the packet dropping usage information by itself, but returns the dropped data packets (i.e., PDU) to the third network node, so that the third network node can collect statistics on the packet dropping usage by itself according to the returned data packets.

In some embodiments, providing the monitored packet dropping usage information to the second network node includes: sending a report to the second network node when the packet dropping usage information satisfies a trigger event, where the report includes the packet dropping usage information.

In the embodiment of the present disclosure, the third network node may determine whether the trigger event for reporting is satisfied according to the statistics on packet dropping usage information collected by itself and/or the packet dropping usage information reported by the access network node, and if satisfied, the third network node may carry the packet dropping usage information in a report and send the report to the second network node.

In some embodiments, sending the report to the second network node when the packet dropping usage information satisfies the trigger event, where the report includes the packet dropping usage information includes: sending the report to the second network node when the packet dropping usage information meets a packet dropping threshold; and/or, sending the report to the second network node when the trigger event occurs in a transmission process of the PDU set.

The trigger event may include: a terminal receiving the PDU set is in arrears, or statistics of indication of the packet dropping usage information of the PDU set, etc. The above are merely examples of the trigger event, and the specific implementation is not limited to the above examples.

In some embodiments, the method further includes: sending event information sent from the second network node, where the event information indicates the trigger event and/or the packet dropping threshold.

The third network node may receive the event information from the second network node in advance, so that the trigger event and/or the packet dropping threshold may be obtained based on the event information.

In some embodiments, the method further includes: determining, based on PDU set information, that data packets received by the second network node belong to a same PDU set.

When statistics is collected on packet dropping usage of the PDU set, it is first necessary to determine whether currently received data packets belong to a same PDU set. Specifically, identification may be performed based on PDU set information.

For example, the third network node may obtain the PDU set information according to an N4 rule and a local configuration.

For example, the PDU set information includes: intra-PDU set information and/or inter-PDU set information.

The intra-PDU set information may be used to identify packets of a single PDU set, etc.

The inter-PDU set information may be used to identify an association relationship between a plurality of PDU sets.

In some embodiments, the intra-PDU set information includes at least one of: a PDU set sequence number; start indication information of a PDU set; end indication information of the PDU set; or a PDU sequence number within the PDU set.

For example, a service data flow may include one or more PDU sets, and a PDU set sequence number may be used to identify different PDU sets in the service data flow.

The start indication information of the PDU set may be used to determine a start data packet of the PDU set, and the end indication information of the PDU set may be used to determine an end data packet of the PDU set.

The PDU sequence number in the PDU set helps the third network node determine, based on a sequence number carried in the data packet, an order of a currently received data packet (PDU) in the PDU set.

It shall be understood that the inter-PDU set information includes at least one of: importance indication information, indicating importance of a corresponding PDU set; or independency indication information, indicating whether the PDU set depends on another PDU set.

In an embodiment, the important indication information is set for important PDU sets, and the important indication information is not set for unimportant PDU sets.

In another embodiment, the important indication information may be set for every PDU set, where specific content of the important indication information indicates importance of the PDU set, and in this case, the important indication information may include level information indicating importance.

The independency indication information may indicate whether the PDU set depends on another PDU set. For example, if none of the data packets in the PDU set depends on a data packet in another PDU set for decoding, the PDU set may be an independent PDU set. If at least one data packet in the PDU set depends on a data packet in another PDU set for decoding, the PDU set is dependent on the other PDU set. Dependencies between such PDU sets may be represented by the independency indication information.

In some embodiments, determining, based on the PDU set information, data packets belonging to a same PDU set includes: determining, based on the PDU set information and at least one of a header or a flow feature of a data packet, whether the corresponding data packet belongs to the PDU set.

In the embodiment of the present disclosure, whether each data packet passing through the third network node belongs to data packets in one PDU set is determined according to the PDU set information, and a header and/or a flow feature of the data packet.

For example, the header of the data packet includes one or more fields, and these fields indicate a type and/or a flow feature of the data packet. For example, the header includes a field indicating a transmission protocol used by the data packet. Whether the data packet received by the third network node belongs to the data packets in the PDU set can be determined based on the field of the transmission protocol.

For another example, whether the data packet received by the third network node belongs to the PDU set is determined based on a type of the header. For example, since different types of headers have different data formats, whether the data packet received by the third network node belongs to the PDU set may be determined based on the data format of the header.

The flow feature includes but is not limited to a triplet and/or a quintuplet of a service data flow. For example, the triplet may include a source Internet Protocol (IP) address, a target IP address, and protocol information. The quintuplet may include a source Internet Protocol (IP) address, a target IP address, a source port number, a destination port number, and protocol information.

In some embodiments, the method further includes: sending the PDU set information to an access network node.

In the embodiment of the present disclosure, the PDU set information is sent to the access network node, so that the access network node can conveniently identify whether the data packet passing through the access network node belongs to the data packet in the PDU set.

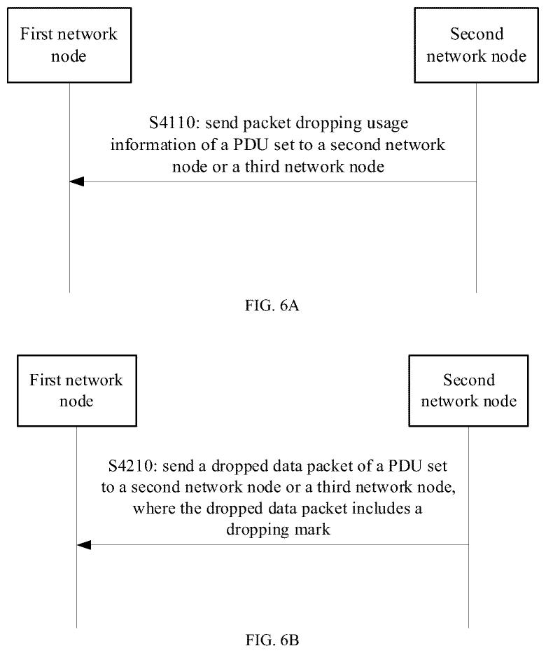

As shown in FIG. 6A, an embodiment of the present disclosure provides an information processing method, performed by an access network node, including:
S4110: sending packet dropping usage information of a PDU set to a second network node or a third network node.

As shown in FIG. 6B, an embodiment of the present disclosure provides an information processing method, performed by an access network node, including:
S4210: sending a dropped data packet of a PDU set to a second network node or a third network node, where the dropped data packet includes a dropping mark.

The access network node may be an access network node such as an eNB and/or a gNB.

In the embodiment of the present disclosure, if the access network node collects statistics on the packet dropping usage data by itself, the access network node collects statistics on an amount of data according to the dropped data packets to obtain the packet dropping usage information.

If the access network node does not collect statistics on packet dropping usage by itself, the access network node returns a dropped data packet to the third network node or the second network node, and the third network node or the second network node collect statistics on packet dropping usage information of the PDU set. To distinguish uplink data packets, the access network node adds a dropping mark to a data packet dropped by the access network node itself, so that the third network node or the second network node collects statistics on the packet dropping usage information based on the dropping mark.

In some embodiments, sending the dropped data packet or the packet dropping usage information of the PDU set to the second network node or the third network node includes: sending, based on the event information of the trigger event or the packet dropping threshold, the dropped data packet or the packet dropping usage information of the PDU set to the second network node or the third network node

In some embodiments, the access network node may report the packet dropping usage information or the dropped data packet in real time. In this embodiment of the present disclosure, to reduce unnecessary reporting, the packet dropping usage or the dropped data packet is reported only when the trigger event is detected; or the packet dropping usage information is reported or the dropped data packet is returned only when it is detected that the packet dropping usage reaches the packet dropping threshold.

In some embodiments, the method further includes: receiving the event information from the second network node or the third network node, where the event information indicates the trigger event.

Before collecting statistics on packet dropping usage information or detecting dropped data packets, the event information is further received from the second network node or the third network node, to determine the trigger event and/or the packet dropping threshold based on the event information.

In some embodiments, the method further includes: receiving PDU set information from the third network node; and determining, based on the PDU set information, that data packets received by an access network node belong to a same PDU set.

In the embodiment of the present disclosure, the access network node also receives the information of the PDU set, so as to identify the data packet of the PDU set according to the PDU set.

In some embodiments, the PDU set information includes: intra-PDU set information and/or inter-PDU set information.

In some other embodiments, the information in the PDU set includes at least one of: a PDU set sequence number; start indication information of a PDU set; end indication information of the PDU set; or a PDU sequence number within the PDU set.

In some embodiments, the inter-PDU set information includes at least one of: importance indication information, indicating importance of a corresponding PDU set; or independency indication information, indicating whether the PDU set depends on another PDU set.

In some embodiments, determining, based on the PDU set information, that the data packets received by the access network node belong to data packets in the same PDU set includes: determining, based on the PDU set information and a header and/or a flow feature of the data packet, whether the data packets received by the access network node belong to the data packets in the PDU set.

In the embodiment of the present disclosure, whether each data packet passing through the access network node belongs to data packets in one PDU set is determined according to the PDU set information, and a header or a flow feature of the data packet.

For example, the header of the data packet includes one or more fields, and these fields indicate a type and/or a flow feature of the data packet. For example, the header includes a field indicating a transmission protocol used by the data packet. Whether the data packet received by the access network node belongs to the data packets in the PDU set can be determined based on the field of the transmission protocol.

For another example, whether the data packet received by the access network node belongs to the PDU set is determined based on a type of the header. For example, since different types of headers have different data formats, whether the data packet received by the third network node belongs to the PDU set may be determined based on the data format of the header.

The flow feature includes but is not limited to a triplet and/or a quintuplet of a service data flow. For example, the triplet may include a source Internet Protocol (IP) address, a target IP address, and protocol information. The quintuplet may include a source Internet Protocol (IP) address, a target IP address, a source port number, a destination port number, and protocol information.

The SMF supports statistics collection of packet dropping usage information for each QoS flow or SDF, each session, and a PDU set of each network slice of a UE. For example, during PDU processing based on the PDU set, the base station monitors usage of the dropped data packet, especially a downlink data packet, to obtain packet dropping usage information.

Monitoring is performed by the PDU set dropping threshold values allocated to the PCC rule of the session or flow, or a PDU session, or all PDU sessions established for a certain UE in a single network slice.

For SDF or PDU sessions, or for all PDU sessions for S-NSSAI (Single Network Slice Selection Assistance Information) transmission, if monitored dropping data usage of a UE's PDU set reaches a certain percentage of the PDU set dropping value, which is detected via thresholds defined by an operator management device or a service provider, the PCF may apply a policy determination to strengthen the traffic restriction of the PDU session or PCC rules.

The traffic restriction herein includes, but is not limited to: the PCF may not allow intended/eligible dropping, or update the PCC rule to change the QoS or charging key.

When the PDU set dropping data usage of a certain flow/PDU session is lower than the percentage of the PDU set dropping value, the PCF may relax the traffic restriction on the flow or PDU session or traffic data flow.

The SMF performs packet dropping usage monitoring based on the monitoring key, to request a report of packet dropping usage information of the PDU set.

The SMF may generate a usage reporting rule for each monitoring key in the activated PCC rules. The monitoring key may be preconfigured on the SMF, or may be received from the PCF.

The SMF also provides event information reporting the trigger event to the UPF/RAN. This event information may be used for when to report packet dropping usage information for a set of PDUs. When detecting that the trigger event or the monitored packet dropping usage reaches the packet dropping threshold, the UPF or the RAN sends the report including the packet dropping usage information to the SMF.

The SMF determines the packet dropping threshold of the PDU set based on authorization of the PCF, a charging trigger function (CTF), or a local configuration. The packet dropping threshold herein may be one of the above packet dropping thresholds. The CTF may be one of the functions included in the SMF.

The UPF and/or the access network node are/is forced to monitor the dropped data of the PDU set, to obtain the packet dropping usage information or record the dropped data packets.

In a case of charging monitoring, the SMF (CTF) reports the charging usage information and/or the packet dropping usage information to the PCF. The CTF may be a charging trigger function (CTF), and the CTF herein may belong to a component of the SMF.

The packet dropping of the PDU set may be caused by following reasons: a PDU set delay budget (PSDB) is exceeded; a PDU set error rate is exceeded; delivery failure of the dependent PDU sets; and delivery failure of important PDU sets.

The delivery herein refers to sending a data packet or a PDU set to a terminal (that is, user equipment (UE)).

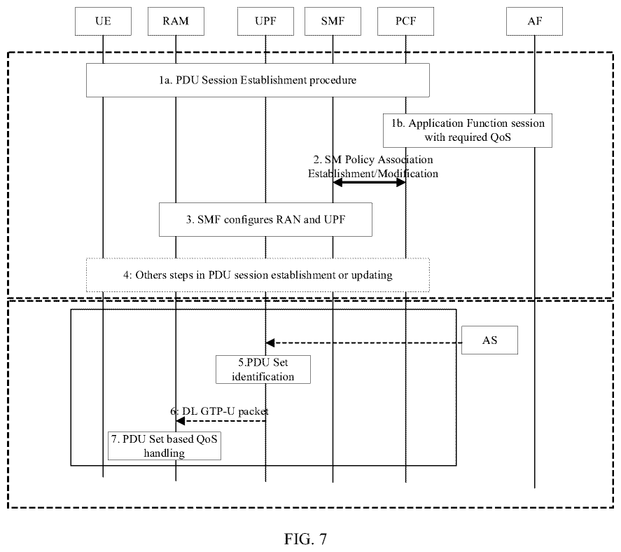

As shown in FIG. 7, an embodiment of the present disclosure provides an information processing method, including:
1a: PDU session establishment; 1b: Application Function (AF) session with required QoS;
2: SM Policy Association Establishment/Updating. SM is an abbreviation for Session Management (SM);
3: SMF configures a UPF and a radio access network (RAN);
4: Other steps in PDU session establishment/updating;
5: PDU set identification, for example, an access of the AF may include PDU entering into the network, etc;
6: Downlink (DL) GPRS Tunneling Protocol-User Plane (GTP-U), where GPRS is an abbreviation of General Packet Radio Service, and corresponding Chinese is: General Packet Radio Service;
7: PDU set based QoS handling.

The PDU set-based traffic restriction determination and/or policy update may occur in a PDU session establishment or modification process, and may specifically include following steps.

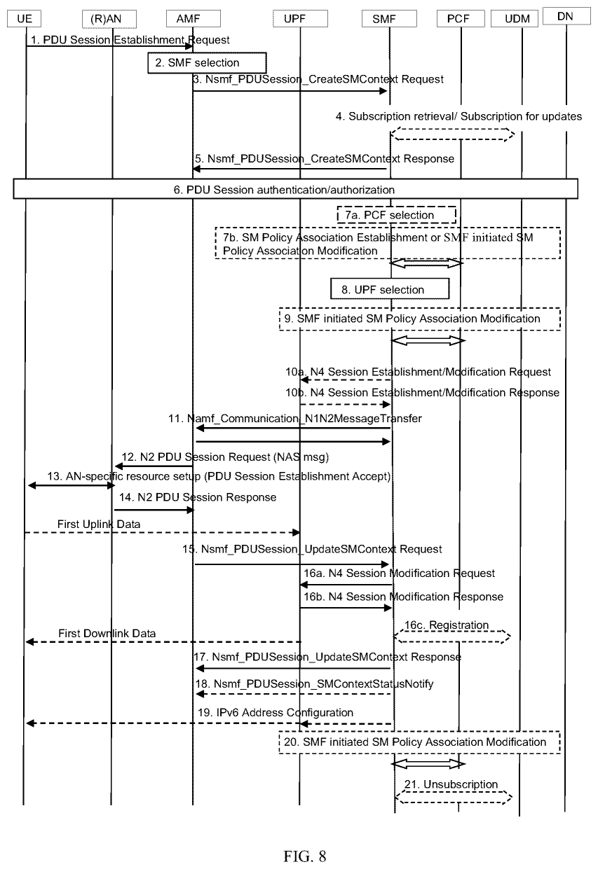

As shown in FIG. 8, a PDU session establishment process may be performed as follows:
Step 1: UE sends a PDU session establishment request to an access management function (AMF) through a (radio) access network ((R)AN);
Step 2: AMF selects SMF;
Step 3: send a Nsmf-PDUSession-CreateSMContextRequest to the selected SMF, where the Nsmf-PDUSession-CreateSMContextRequest requests to establish a PDU session;
Step 4: SMF obtains subscription data from a unified data management (UDM);
Step 5: SMF returns a Nsmf-PDUSession-CreateSMContextResponse to AMF;
Step 6: PDU session authentication/authorization;
Step 7a: PCF selection;
Step 7b: SMF may perform an SM Policy Association Establishment procedure to establish an SM policy association with the PCF and obtain a default PCC rule for the PDU session. For ON-SNPN (Onboarding Stand-alone Non-Public Network), the SMF shall include GPSI (Generic Public Subscription Identifier), PVS FQDN (Provisioning and Verification Server Fully Qualified Domain Name) or PVS IP address and Onboarding Indication (if any). If the request type in step 3 indicates an existing PDU session, the SMF may provide information about policy control request trigger conditions that have been satisfied by the SMF-initiated SM policy association modification procedure. PCF may provide the policy to the SMF.

PCF generates and provides PCC rules, including QoS and usage monitoring information related to the PDU set, to the SMF.

The PCF supports monitoring of packet dropping usage information of a PDU set per SDF, per session, and per S-NSSAI of a UE (when QoS processing is performed based on the PDU set, usage of a data packet dropped by RAN, especially a downlink data packet).

The monitoring is performed by the PDU set dropping thresholds values allocated to the PCC rules of the SDFs, or the PDU session, or the all PDU Sessions established for a UE in the S-NSSAI.

(For the SDFs, or for the PDU session, or for the S-NSSAI), if the monitored data usage for PDU set dropping for a UE reaches a certain percentage of the PDU set dropping value (detected via operator/Application Service Provider defined thresholds), the PCF may apply a policy decision to strengthen the traffic restrictions for the PDU Sessions or PCC rules (e.g. not allow to be intended/eligible dropping, or update PCC Rule(s) to change QoS or charging keys(s)), and interact with the SMF accordingly. When the data usage of PDU set dropping for a UE falls below that percentage of the PDU set dropping value, the PCF may relax the traffic restrictions for PDU Sessions or PCC rules.

The QoS parameter related to the PDU set is a new QoS parameter processed based on QoS of the PDU set in the 5GS, and may further include: a PDU set delay budget (PSDB), a PDU set error rate (PSER), whether all PDUs are needed for the usage of PDU Set by application layer, whether to drop a PDU set in case PSDB is exceeded, PDU Set Priority, the “PDU Set Priority” be the same for all PDU Sets (i.e. same as existing QoS Flow Priority) or it be different for each PDU Set (i.e. same as “PDU Set importance”).

Steps 8-15: the SMF generates QoS profiles and N4 rules based on the PCC rules from PCF. SMF sends the N4 rules to UPF and sends the QoS profiles to the RAN node via AMF.

The SMF requests the report of the PDU set dropping usage information for Usage Monitoring based on Monitoring Keys and triggers. The SMF generates the Usage Reporting Rule for each Monitoring-key within the active PCC Rule(s), either preconfigured or received from the PCF.

The SMF also provides reporting trigger events to the UPF/RAN for when to report PDU set dropping usage information. The reporting trigger events (e.g. triggers, threshold information etc.) is supported for the rule level reporting or the PDU Session level reporting.

The SMF decides on the PDU set dropping thresholds value(s) based on allowance received from PCF, CHF or based on local configuration. The monitoring of PDU set dropping data usage is enforced in the UPF and/or the NG-RAN.

If charging monitoring, The SMF (CTF) report the charging usage information (measured at the UPF and the RAN offset) to the CHF.

Step 16a: N4 Session Modification Request;

Step 16b: N4 Session Modification Response;

Step 16c: Registration;

Step 17: Nsmf-PDUSession-UpdateSMContextStatusrequest;

Step 18: Nsmf-PDUSession-UpdateSMContextStatusNotify;

Step 18: N4 Session Modification Request;

Step 19: IPv6 Address Configuration;

Step 20: SMF initiates SM Policy Association Modification;

Step 21: Unsubscription.

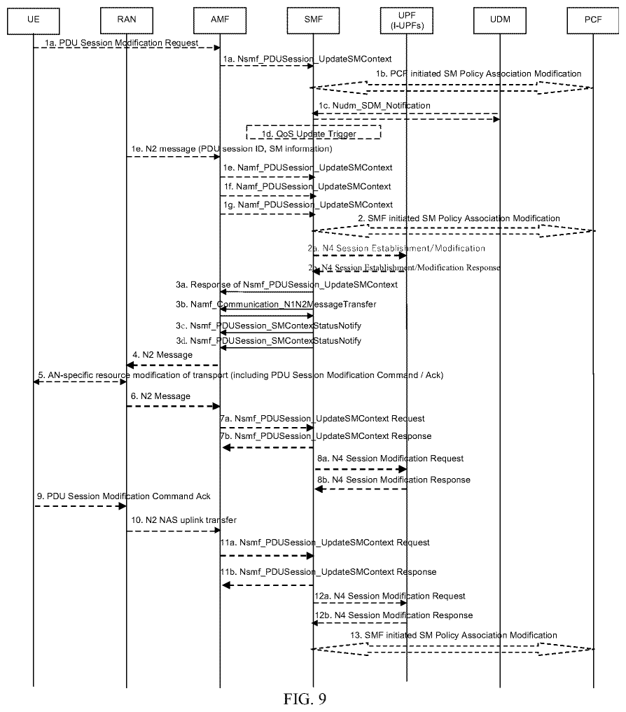

As shown in FIG. 9, a PDU session modification procedure may be as follows:
Step 1a: UE sends a PDU session establishment request to an access management function (AMF) through a (radio) access network ((R)AN);
Step 1b: PCF initiates SM Policy Association Modification, PCF performs a PCF initiated SM Policy Association Modification procedure to notify SMF about the modification of policies;
Step 1c: SMF exchanges Nudm-SDM-Notification with UDM, where Nudm-SDM-Notification is used for exchanging of PDU session update between SMF and UDM;
Step 1d: QoS update trigger;
Step 1e: N2 message, where the N2 message includes a PDU session ID and session management information, and AMF sends Namf-PDUSession-UpdateSMContext to SMF;
Step 1f: Namf-PDUSession-UpdateSMContext;
Step 1g: Namf-PDUSession-UpdateSMContext;
(steps 1e-1g are optional steps, and may be one or more pieces of information about PDU session modification exchanged between AMF and SMF);
Step 2: SMF initiates an SM policy association modification, and the SMF initiates an SM policy association notification;
Step 2a: N4 session establishment/modification;
Step 2b: N4 session establishment/modification response;
Step 3a: Response of PDUSession-UpdateSMContext;
Step 3b: Namf-Conmmunication-NIN2MessageTransfer;
Step 3c: Nsmf-PDUSession-SMContextStatusNotify;
Step 3d: Nsmf-PDUSession-SMContextStatusNotify;
Step 4: N2 message;
Step 5: access network (AN)-specific resource modification of transport (including PDU session modification command/ACK);
Step 6: N2 message;
Step 7a: Nsmf-PDUSession-UpdateSMContextStatusrequest;
Step 7b: Nsmf-PDUSession-UpdateSMContextStatusresponse;
Step 8a: N4 Session Modification Request; Step 8b: N4 Session Modification Response;
Step 9: PDU session modification command acknowledgement;
Step 10: N2 Non Stratum Access (NAS) uplink (UL) transmission;
Step 11a: Nsmf-PDUSession-UpdateSMContextStatusrequest;
Step 11b: Nsmf-PDUSession-UpdateSMContextStatusresponse;
Step 12a: N4 Session Modification Request;
Step 12b: N4 Session Modification Response;
Step 13: SMF initiates an SM Policy Association Modification.

Specifically, PCF generates and provides a PCC rule, where the PCC rule may include a QoS parameter and usage monitoring information related to a PDU set, and provides the PCC rule to SMF.

PCF supports packet dropping usage information of a PDU set per SDF, per session, and per single network slice selection assistance information (S-NSSAI) of one UE.

For SDF, or for PDU session, or for S-NSSAI, if the packet dropping usage of a UE's PDU set reaches a certain percentage of the PDU set dropping value, the PCF may apply a policy determination to strengthen the traffic restriction of the PDU session or PCC rule. The traffic restriction may include, but is not limited to: not allowing intended packet dropping/allowing intended packet dropping, or updating the PCC rule to change QoS or a charging key, and performing corresponding interaction with the SMF. When the data usage of PDU set dropping for a UE falls below that percentage of the PDU set dropping value, the PCF may relax the traffic restrictions for PDU Sessions or PCC rules.

The QoS parameter related to the PDU set is a new QoS parameter processed based on QoS of the PDU set in the 5GS (5th mobile communication system), and may further include at least one of: a PDU set delay budget (PSDB), a PDU set error rate (PSER), whether all PDUs in the PDU set are needed by application layer, whether to drop a PDU set in case PSDB is exceeded, or PDU Set Priority, the “PDU Set Priority” be the same for all PDU Sets or it be different for each PDU Set.

The SMF generates QoS profiles and N4 rules based on the PCC rules from PCF. The SMF sends the N4 rules to UPF and sends the QoS profiles to the RAN node via AMF.

The SMF requests the report of the PDU set dropping usage information for Usage Monitoring based on Monitoring Keys and triggers. The SMF generates the Usage Reporting Rule for each Monitoring-key within the active PCC Rule(s), either preconfigured on the SMF or received from the PCF by the SMF.

The SMF also provides event information of trigger event to the UPF/RAN for when to report PDU set dropping usage information. The packet dropping usage information is reported, and rule level reporting or the PDU session level reporting is supported.

The SMF decides on the PDU set dropping thresholds value(s) based on allowance received from PCF, CHF or based on local configuration. The packet dropping threshold herein may be one of the above packet dropping thresholds.

The monitoring of PDU set dropping data usage is enforced in the UPF and/or the NG-RAN.

If charging monitoring, The SMF (CTF) report the charging usage information, where the charging usage information may be information indicating charging usage, and specifically, the charging usage indicated by the charging usage information may be to-be-charged usage from which the dropping usage indicated by the packet dropping usage information has been deducted.

The RAN performs usage measurement, statistics collection, and reporting on a corresponding dropped data packet in the PDU set.

The RAN collects/measures which downlink data packets will be dropped, and reports them to the UPF. The RAN reports usage data to the source UPF for policy update.

The RAN collects and reports the usage per serving data flow, or per QoS flow, or per entire PDU session.

As shown in FIG. 10, an embodiment of the present disclosure provides an information processing apparatus 100, including: a receiving module 102, configured to receive packet dropping usage information of a protocol data unit (PDU) set sent by a second network node.

The information processing apparatus 100 in the embodiment of the present disclosure may include the first network node.

The receiving module 102 may be various transceiver antennas, network interfaces, or the like.

The information processing apparatus may further include: a storage module, connected to the receiving module 102, and may be at least configured to store the packet dropping usage information.

In some embodiments, the apparatus further includes: a determining module, configured to determine a traffic restriction based on the packet dropping usage information; and/or correct charging usage based on the packet dropping usage information.

The processing module may be various components having a processing function, for example, a central processing unit, a digital model processor, or an embedded processor.

In some embodiments, a data level related to the PDU set includes at least one of: a service data flow (SDF); a PDU session; or all PDU sessions transmitted by a network slice of a user equipment (UE).

In some embodiments, the processing module is configured to update a policy control and charging (PCC) rule of policy information according to the packet dropping usage information.

In some embodiments, the processing module is configured to: update a quality of service (QoS) parameter of the PCC rule according to the packet dropping usage information; and/or update a charging key of the PCC rule according to the packet dropping usage information.

In some embodiments, the QoS parameter includes at least one of: a PDU set delay budget (PSDB); a PDU set error rate (PSER); first indication information, indicating whether all data packets in the PDU set are needed by an application layer; second indication information, indicating whether to allow packet dropping in a case that the PDU set meets a preset condition; or a priority of the PDU set.

In some embodiments, the processing module is configured to allow intended packet dropping according to the packet dropping usage information; or prohibit intended packet dropping according to the packet dropping usage information.

In some embodiments, the processing module is further configured to determine the traffic restriction according to the packet dropping usage information based on the packet dropping usage information being greater than or equal to a packet dropping threshold.

In some embodiments, the packet dropping threshold includes at least one of: a packet dropping usage percentage; or, a packet dropping usage.

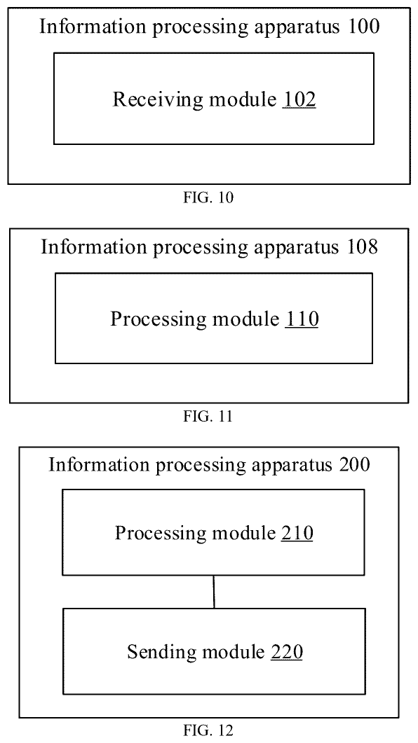

As shown in FIG. 11, an embodiment of the present disclosure provides an information processing apparatus 108, including: a processing module 110, configured to monitor packet dropping usage information of a protocol data unit (PDU) set.

The processing module 110 may be various components having a processing function, for example, a central processing unit, a digital model processor, or an embedded processor.

The information processing apparatus 108 in the embodiment of the present disclosure may include the second network node.

The information processing apparatus may further include: a storage module, connected to the processing module 110, and may be at least configured to store the packet dropping usage information.

In some embodiments, the apparatus further includes: a sending module, configured to send the packet dropping usage information to a first network node, where the packet dropping usage information is used for charging usage correction and/or policy updating by the first network node; or, a sending module, configured to perform charging usage correction according to the packet dropping usage information.

The sending module may be various transceiver antennas, network interfaces, or the like.

In some embodiments, the processing module 110 is configured to receive, according to a monitoring key, packet dropping usage information of a PDU set from a third network node.

In some embodiments, the processing module 110 is configured to send a report to the third network node or the access network node according to the monitoring key; where the report includes packet dropping usage information of the PDU set.

In some embodiments, the report is reported when the third network node or the access network node determines that a trigger event is satisfied.

In some embodiments, the apparatus further includes: a sending module, configured to send event information of a trigger event to the third network node or the access network node.

In some embodiments, the monitoring key is preconfigured on the second network node; or, the monitoring key is received by the second network node from the first network node.

In some embodiments, the processing module 110 is further configured to determine, based on at least one of policy information provided by a PCF, authorization information of the first network node, or local configuration information of the second network node, the packet dropping threshold related to the trigger event.

As shown in FIG. 12, an embodiment of the present disclosure provides an information processing apparatus 200, including: a processing module 210, configured to acquire packet dropping usage information of a protocol data unit (PDU) set; a sending module 220, configured to provide the monitored packet dropping usage information to a second network node.

The information processing apparatus 200 may include the third network node.

The processing module 210 may be various components having a processing function, for example, a central processing unit, a digital model processor, or an embedded processor.

The sending module 220 may be various transceiver antennas, network interfaces, or the like.

The sending module 220 is connected to the processing module 210.

In some embodiments, the processing module 210 is configured to: receive packet dropping usage information of the PDU set from an access network node; or receive a dropped data packet provided by the access network node, and determine the packet dropping usage information based on the dropped data packet, where the dropped data packet includes a dropping mark.

In some embodiments, the sending module 220 is configured to send a report to the second network node according to the packet dropping usage information and the event information, where the report includes the packet dropping usage information.

In some embodiments, the sending module 220 is configured to: send the report to the second network node when packet dropping usage indicated by the packet dropping usage information is greater than or equal to a packet dropping threshold; and/or send a report to the second network node when a trigger event occurs in a transmission process of the PDU set.

In some embodiments, the sending module 220 is further configured to send event information sent from the second network node, where the event information indicates the trigger event and/or the packet dropping threshold.

In some embodiments, the processing module 210 is further configured to determine, based on PDU set information, that data packets received by the second network node belong to a same PDU set.

In some embodiments, the PDU set information includes: intra-PDU set information and/or inter-PDU set information.

In some embodiments, the intra-PDU set information includes at least one of: a PDU set sequence number; start indication information of a PDU set; end indication information of the PDU set; or a PDU sequence number within the PDU set.

In some embodiments, the inter-PDU set information includes at least one of: importance indication information, indicating importance of a corresponding PDU set; or independency indication information, indicating whether the PDU set depends on another PDU set.

In some embodiments, the processing module 110 is configured to determine, based on the PDU set information and at least one of a header or a flow feature of a data packet, whether the corresponding data packet belongs to the PDU set.

In some embodiments, the sending module is configured to send the PDU set information to the access network node.

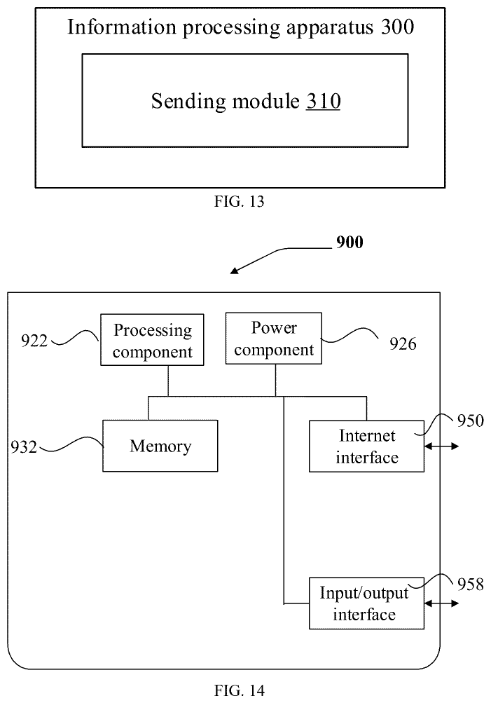

As shown in FIG. 13, an embodiment of the present disclosure provides an information processing apparatus 300, including: a sending module 310, configured to send a dropped data packet or packet dropping usage information of a protocol data unit (PDU) set to a second network node or a third network node, where the dropped data packet includes a dropping mark.

The information processing apparatus 300 may include an access network node.

The sending module 310 may be various transceiver antennas, network interfaces, or the like.

The information processing apparatus 300 may further include a storage module and/or a processing module (not shown) connected to the sending module 310. The storage module may be configured to store information, and may include various types of storage media, such as non-transitory storage media.

The processing module may be various components having a processing function, for example, a central processing unit, a digital model processor, or an embedded processor.

In some embodiments, the sending module 310 is configured to send, based on the event information of the trigger event or the packet dropping threshold, the dropped data packet or the packet dropping usage information of the PDU set to the second network node or the third network node.

In some embodiments, the apparatus 300 further includes: a receiving module (not shown), configured to receive the event information sent by the second network node or the third network node, where the event information indicates the trigger event or the packet dropping threshold.

In some embodiments, the apparatus 300 further includes: a receiving module (not shown), configured to receive PDU set information from a third network node; and a processing module, configured to determine, based on the PDU set information, that data packets received by an access network node belong to a same PDU set.

In some embodiments, the PDU set information includes: intra-PDU set information and/or inter-PDU set information.

In some embodiments, the processing module is configured to determine, based on the PDU set information and at least one of a header or a flow feature of a data packet, whether the data packet received by the access network node belongs to the PDU set.

An embodiment of the present disclosure provides an information processing apparatus, including: a receiving module, configured to receive packet dropping usage information of a protocol data unit (PDU) set sent by a second network node.

The information processing apparatus may include the first network node.

It shall be understood that the apparatus further includes: a determining module, configured to determine a traffic restriction based on the packet dropping usage information; and/or correct charging usage based on the packet dropping usage information.

It may be understood that a data level related to the PDU set includes at least one of: a service data flow (SDF); a PDU session; or all PDU sessions transmitted by a network slice of a user equipment (UE).

It shall be understood that determining the traffic restriction based on the packet dropping usage information includes: updating a policy control and charging (PCC) rule of policy information according to the packet dropping usage information.

It shall be understood that updating the PCC rule of the policy information according to the packet dropping usage information includes: updating a quality of service (QoS) parameter of the PCC rule according to the packet dropping usage information; and/or, updating a charging key of the PCC rule according to the packet dropping usage information.

It shall be understood that the QoS parameter includes at least one of: a PDU set delay budget (PSDB); a PDU set error rate (PSER); first indication information, indicating whether all data packets in the PDU set are needed by an application layer; second indication information, indicating whether to allow packet dropping in a case that the PDU set meets a preset condition; or a priority of the PDU set.

It may be understood that the processing module is configured to: allow intended packet dropping based on the packet dropping usage information; or prohibit intended packet dropping based on the packet dropping usage information.

It shall be understood that the processing module is configured to determine the traffic restriction based on the packet dropping usage information in a case that a packet dropping usage indicated by the packet dropping usage information is greater than or equal to a packet dropping threshold.

It shall be understood that the packet dropping threshold includes at least one of: a packet dropping usage percentage; or a packet dropping usage.

It shall be understood that the first network node includes a policy function information (PCF).

An embodiment of the present disclosure provides an information processing apparatus, including: a sending module, configured to send packet dropping usage information of a protocol data unit (PDU) set to a first network node.

The information processing apparatus may include a second network node.

It shall be understood that the apparatus further includes: a receiving module, configured to receive, according to a monitoring key, the packet dropping usage information of the PDU set from a third network node.

It may be understood that the receiving module is configured to receive a report of the packet dropping usage information of the PDU set from the third network node according to a monitoring key.

It shall be understood that the apparatus further includes: a receiving module, configured to receive, according to a monitoring key, a dropped data packet in the PDU set sent by a third network node, where the dropped data packet includes a dropping mark; and a processing module, configured to determine the packet dropping usage information of the PDU set based on the dropped data packet.

It shall be understood that the third network node includes a user plane function (UPF).

It shall be understood that the apparatus further includes: a receiving module, configured to acquire, according to a monitoring key, the packet dropping usage information of the PDU set from an access network node.

It shall be understood that, the receiving module is configured to receive, according to the monitoring key, the packet dropping usage information of the PDU set from the access network node.

It shall be understood that the apparatus further includes: a receiving module, configured to receive, according to a monitoring key, a dropped data packet in the PDU set sent by an access network node, where the dropped data packet includes a dropping mark; and a determining module, configured to determine the packet dropping usage information of the PDU set based on the dropped data packet.

It shall be understood that the access network node is an access network node.

It shall be understood that the monitoring key is preconfigured on the second network node; or, the monitoring key is received by the second network node from the first network node.

It shall be understood that the packet dropping usage information is used by the first network node to correct charging usage, or update policy information, or both.

The second network node includes a session management function (SMF).

An embodiment of the present disclosure provides an information processing apparatus, including: a receiving module, configured to receive packet dropping usage information of a protocol data unit (PDU) set sent by a third network node; a processing module, configured to correct a charging usage according to the packet dropping usage information; and a sending module, configured to send the corrected charging usage to a charging function.

An embodiment of the present disclosure provides an information processing apparatus, including: a receiving module, configured to receive packet dropping usage information of a protocol data unit (PDU) set sent by an access network node; a processing module, configured to correct a charging usage according to the packet dropping usage information; and a sending module, configured to send the corrected charging usage to a charging function.

An embodiment of the present disclosure provides an information processing apparatus, including: a receiving module, configured to receive a dropped data packet of a protocol data unit (PDU) set sent by a third network node, where the dropped data packet includes a dropping mark; a processing module, configured to determine the packet dropping usage information of the PDU set based on the dropped data packet; and perform charging usage correction according to the packet dropping usage information.

An embodiment of the present disclosure provides an information processing apparatus, including: a receiving module, configured to receive a dropped data packet of a protocol data unit (PDU) set sent by an access network node, where the dropped data packet includes a dropping mark; a processing module, configured to determine the packet dropping usage information of the PDU set based on the dropped data packet; and perform charging usage correction according to the packet dropping usage information; and a sending module, configured to send the corrected charging usage to a charging function.

An embodiment of the present disclosure provides an information processing apparatus, including: a sending module, configured to send a dropped data packet of a protocol data unit (PDU) set to a second network node, where the dropped data packet includes a dropping mark.

An embodiment of the present disclosure provides an information processing apparatus, including: a sending module, configured to send a dropped data packet of a protocol data unit (PDU) set to a third network node, where the dropped data packet includes a dropping mark.

An embodiment of the present disclosure provides an information processing apparatus, including: a sending module, configured to send packet dropping usage information of a protocol data unit (PDU) set to a second network node.

An embodiment of the present disclosure provides a communication system, including a first network node, a second network node, and a third network node; where the third network node is configured to send packet dropping usage information of a protocol data unit (PDU) set to the second network node; the second network node is configured to receive the packet dropping usage information sent by the third network node and send the packet dropping usage information to the first network node; and the first network node is configured to receive the packet dropping usage information sent by the second network node, and correct a charging usage, or determine a traffic restriction, or both, according to the packet dropping usage information.

It shall be understood that the communication system further includes: an access network node, configured to obtain the packet dropping usage information based on a dropped data packet in the PDU set, and send the packet dropping usage information to the third network node.

It shall be understood that the communication system further includes: an access network node, configured to send a dropped data packet in the PDU set to the third network node, where the dropped data packet includes a dropping mark; and the third network node is configured to receive the dropped data packet to obtain the packet dropping usage information.

An embodiment of the present disclosure provides a communication system, including a first network node, a second network node, and an access network node; where the access network node is configured to send packet dropping usage information of a protocol data unit (PDU) set to the second network node; the second network node is configured to receive the packet dropping usage information sent by the third network node and send the packet dropping usage information to the first network node; and the first network node is configured to receive the packet dropping usage information sent by the second network node, and correct a charging usage, or determine a traffic restriction, or both, according to the packet dropping usage information.

An embodiment of the present disclosure provides a communication system, including a first network node, a second network node, and an access network node; where the access network node, configured to send a dropped data packet in the PDU set to the third network node, where the dropped data packet includes a dropping mark that is sent to the second network node; and the second network node is configured to receive the dropped data packet, to obtain the packet dropping usage information of the PDU set, and send the packet dropping usage information to the first network node; and the first network node is configured to receive the packet dropping usage information sent by the second network node, and correct a charging usage, or determine a traffic restriction, or both, according to the packet dropping usage information.

An embodiment of the present disclosure provides a communication system, including: a second network node, an access network node and a charging function; the access network node is configured to send packet dropping usage information of a protocol data unit (PDU) set to the second network node; the second network node is configured to receive the packet dropping usage information sent by the access network node, perform charging usage correction according to the packet dropping usage information, and send corrected charging usage to the charging function; and the charging function is configured to charge according to the corrected charging usage.

An embodiment of the present disclosure provides a communication system, including: a second network node, an access network node and a charging function; the access network node is configured to send a dropped data packet of a protocol data unit (PDU) set to a second network node, where the dropped data packet includes a packet dropping mark; the second network node is configured to receive a dropped data packet sent by the access network node, obtain packet dropping usage information of the PDU set according to the dropped data packet, perform charging usage correction according to the packet dropping usage information, and send corrected charging usage to the charging function; and the charging function is configured to charge according to the corrected charging usage.

An embodiment of the present disclosure provides a communication system, including: a second network node, a third network node and a charging function; the access network node is configured to send packet dropping usage information of a protocol data unit (PDU) set to the second network node; the second network node is configured to receive the packet dropping usage information sent by the access network node, perform charging usage correction according to the packet dropping usage information, and send corrected charging usage to the charging function; and the charging function is configured to charge according to the corrected charging usage.

It should be noted that, in any embodiment of the present disclosure, the first network node includes but is not limited to a PCF; the second network node includes but is not limited to an SMF; the third network node includes but is not limited to a UPF; and the access network node includes but is not limited to an eNB, a gNB, or the like.

An embodiment of the present disclosure provides a communication device, including: a memory for storing a processor-executable instruction; and a processor, connected to the memory; where the processor is configured to perform the information processing method provided in any of the above technical solutions.

The processor may include various types of storage medium, which is a non-transitory computer storage medium capable of maintaining information stored thereon when power is cut for the communication device.

The communication device herein includes a network node, and for example, the network node may be any one of the first network node, the second network node, the third network node, or the access network node.

The processor may be connected to the memory through a bus, and is configured to read an executable program stored in the memory, for example, at least one of the methods shown in FIG. 2, FIG. 3A to FIG. 3D, FIG. 4A to FIG. 4D, FIG. 5A to FIG. 5C, FIG. 6A to FIG. 6B, and FIG. 7 to FIG. 9.

In an example embodiment, there is further provided a non-transitory computer-readable storage medium including an instruction, such as a memory including the instruction, where the instruction is executable by a processor of the UE to perform the above method. For example, the non-transitory computer-readable storage medium may be a ROM (read-only memory), a RAM (random access memory), CD-ROM (compact disc read-only memory), magnetic tape, floppy disk, optical data storage device, or the like.

As shown in FIG. 14, an embodiment of the present disclosure shows a structure of a network device. For example, the network device 900 may be provided as a network side device.

Referring to FIG. 14, the network device 900 includes a processing component 922, which further includes one or more processors, and memory resources represented by a memory 932 for storing instructions executable by the processing component 922, such as application programs. The application program stored in the memory 932 may include one or more modules each corresponding to a set of instructions. In addition, the processing component 922 is configured to execute instructions to perform any method applied to the access device as described above, for example, at least one of the methods shown in FIGS. 2, 3A to 3D, 4A to 4D, 5A to 5C, 6A to 6B, and 7 to 9.

The network device 900 may further include a power component 926 configured to perform power management of the network device 900, a wired or wireless network interface 950 configured to connect the network device 900 to a network, and an input/output (I/O) interface 958. Network device 900 may operate based on an operating system stored in memory 932, such as Windows Server™, Mac OS X™, Unix™, Linux™, Free BSD™, or the like.

An embodiment of the present disclosure provides a computer storage medium, where the computer storage medium stores an executable program; and when the executable program is executed by a processor, at least one of the methods shown in FIG. 2, FIG. 3A to FIG. 3C, FIG. 4A to FIG. 4C, FIG. 5A to FIG. 5C, FIG. 6A to FIG. 6B, and FIG. 7 to FIG. 9 can be implemented. The computer storage medium may include, but is not limited to, a non-transitory computer readable storage medium.

Other embodiments of the present disclosure will easily occur to those skilled in the art after considering the specification and practicing the present disclosure herein. The present application is intended to cover any variations, uses or adaptations of the present disclosure, which follow the general principles of the present disclosure and include common sense or common technical means in this technical field that are not disclosed in the present disclosure. The specification and examples are to be regarded as examples only, with the true scope and spirit of the present disclosure being indicated by the following claims.

It should be understood that the present disclosure is not limited to the precise structures described above and shown in the accompanying drawings, and various modifications and changes may be made without departing from the scope thereof. The scope of the present disclosure is limited only by the appended claims.

1. An information processing method, performed by a first network node, comprising:
receiving packet dropping usage information of a protocol data unit (PDU) set sent by a second network node.

2. The method according to claim 1, further comprising:
determining a traffic restriction according to the packet dropping usage information; and/or,
correcting a charging usage according to the packet dropping usage information.

3. The method according to claim 2, wherein a data level related to the PDU set comprises at least one of:
a service data flow (SDF);
a PDU session; or
all PDU sessions transmitted by a network slice of a user equipment (UE).

4. The method according to claim 2, wherein determining the traffic restriction according to the packet dropping usage information comprises:
updating a policy control and charging (PCC) rule of policy information according to the packet dropping usage information.

5. The method according to claim 4, wherein updating the PCC rule of the policy information according to the packet dropping usage information comprises:
updating a quality of service (QOS) parameter of the PCC rule according to the packet dropping usage information; and/or,
updating a charging key of the PCC rule according to the packet dropping usage information.

6. The method according to claim 5, wherein the QoS parameter comprises at least one of:
a PDU set delay budget (PSDB);
a PDU set error rate (PSER);
first indication information, indicating whether all data packets in the PDU set are needed by an application layer;
second indication information, indicating whether to allow packet dropping in a case that the PDU set meets a preset condition; or
a priority of the PDU set.

7. The method according to claim 2, wherein determining the traffic restriction according to the packet dropping usage information further comprises:
allowing intended packet dropping according to the packet dropping usage information; or
prohibiting intended packet dropping according to the packet dropping usage information.

8. The method according to claim 2, wherein determining the traffic restriction according to the packet dropping usage information comprises:
determining the traffic restriction based on the packet dropping usage information in a case that a packet dropping usage indicated by the packet dropping usage information is greater than or equal to a packet dropping threshold.

9. The method according to claim 8, wherein the packet dropping threshold comprises at least one of:
a packet dropping usage percentage; or
a packet dropping usage.

10. The method according to claim 1, wherein the first network node comprises a policy control function (PCF).

11. An information processing method, performed by a second network node, comprising:
sending packet dropping usage information of a protocol data unit (PDU) set to a first network node.

12. The method according to claim 11, further comprising:
receiving, according to a monitoring key, the packet dropping usage information of the PDU set from a third network node; or,
receiving, according to a monitoring key, a dropped data packet in the PDU set sent by a third network node, wherein the dropped data packet comprises a dropping mark; and determining the packet dropping usage information of the PDU set based on the dropped data packet;
the third network node comprises a user plane function (UPF).

13.-14. (canceled)

15. The method according to claim 11, further comprising:
receiving, according to a monitoring key, the packet dropping usage information of the PDU set from an access network node.

16. The method according to claim 11, further comprising:
receiving, according to a monitoring key, a dropped data packet in the PDU set sent by an access network node, wherein the dropped data packet comprises a dropping mark; and
determining the packet dropping usage information of the PDU set based on the dropped data packet.

17. The method according to claim 12, wherein
the monitoring key is preconfigured on the second network node; or
the monitoring key is received by the second network node from the first network node;
wherein the packet dropping usage information is used by the first network node to correct charging usage, or update policy information, or both;
the second network node comprises a session management function (SMF).

18.-19. (canceled)

20. An information processing method, performed by a third network node, comprising:
sending packet dropping usage information of a protocol data unit (PDU) set to a second network node.

21. The method according to claim 20, further comprising:
receiving the packet dropping usage information of the PDU set sent by an access network node; or,
receiving a dropped data packet in the PDU set sent by the access network node, and determining the packet dropping usage information of the PDU set based on the dropped data packet, wherein the dropped data packet comprises a dropping mark.

22-34. (canceled)

35. A communication system, comprising a first network node according to claim 1, a second network node according to claim 11, and a third network node according to claim 20.

36.-37. (canceled)

38. A communication device, comprising a processor, a transceiver, a memory, and an executable program stored in the memory and executable by the processor, wherein when the processor executes the executable program, the information processing method according to claim 1, is performed.

39. A non-transitory computer storage medium, wherein the computer storage medium stores an executable program, and when the executable program is executed by a processor, the information processing method according to claim 1 is implemented.
